(19) United States
(12) Patent Application Publication
(10) Pub. No.: US 2008/0230175 A1
(43) Pub. Date: Sep. 25, 2008

(54) Cleaning Device and a Method For Producing a Cleaning Device For Cleaning a Read and/or Write Interface of a Read and/or Write Unit

(75) Inventors: Joseph Frederick Fritsch, Kerry (IE); Roxanne Yvonne Fritsch, Kerry (IE)

Correspondence Address: SUGHRUE MION, PLLC, 2100 PENNSYLVANIA AVENUE, N.W., SUITE 800, WASHINGTON, DC, 20037, US

(73) Assignees: Roxanne Yvonne Fritsch, Tralee (IE); Joseph Frederick Fritsch, Tralee (IE)

(21) Appl. No.: 12/067,249

(22) PCT Filed: Sep. 19, 2006
(86) PCT No.: PCT/IE2006/000101

§ 371 Date: May 22, 2008

(30) Foreign Application Priority Data
Sep. 19, 2005 (IE) S2005/0616

(51) Int. Cl. B29C 65/00; B29C 65/70; G11B 3/58

(52) U.S. Cl. 156/242; 156/293; 369/71

(57) ABSTRACT

A cleaning device (1) for cleaning a lens of an optical head of an optical disc drive unit comprises a carrier disc (2) similar to a compact disc or a CD-ROM disc for inserting in a disc receiving area of the optical disc drive unit. A brush type element 97) comprising a woven base member 99) with tufted filaments (10) extending from the base member (9) is located in a receiving recess (5) in the carrier disc 92). The filaments (10) are flexible relative to the base member (9), and the tufting of the filaments in the base member (9) permits limited hinging of the filaments (10) relative to the base member (9). The depth of the base member (9) is less than the depth of the receiving recess (5), and the area of the base member 99) relative to the area of the receiving recess (5) is such as not to inhibit the flexibility of the filaments (10) relative to the base member (9). The carrier disc (2) is rotated in the disc receiving area of the optical disc drive unit, so that the brush type element (7) wipes the lens of the optical head for cleaning thereof.

The present invention relates to a cleaning device, and in particular, to a cleaning device for cleaning a read and/or write interface of a read and/or write unit, and/or a playback and/or recorder unit, and in particular, though not limited to a cleaning device for cleaning a lens of an optical head of an optical disc read and/or write unit. The invention also relates to a method for producing a cleaning device for cleaning a read and/or write interface of a read and/or write unit, and/or a playback and/or recorder unit.

Read and/or write units, as well as playback and/or recorder units, typically comprise a recordable medium receiving area for receiving a medium with recorded data thereon, and a read/write interface adjacent the recordable medium receiving area for interfacing with the medium with the recorded data thereon for reading the data from the medium or for writing data thereto. The read data is processed in a data processing unit, which may be a video playback and/or recorder unit, an audio playback and/or recorder unit, a computer or the like. The data to be written by the interface onto the medium in the recordable medium receiving area similarly may be video data from a video system, audio data from an audio system, or data from a computer. In general, such data is digital data, although in analogue systems, the data may be written in the form of analogue data. This would be particularly the case in video and audio playback and/or recorder units. Such read and/or write units and playback and/or recorder units may be adapted for reading and/or writing magnetically stored data or optically stored data. Where the data is stored on a magnetic medium, the interface, typically, comprises a magnetic head which reads or writes the data to or from the magnetic medium. Where the data is optically stored on an optical medium, the interface comprises an optical head which includes a lens through which light reflected from the medium is read or through which light is passed for recording data onto the medium.

The efficient operation of such read and/or write units, and/or playback and/or recorder units require that the interface, be it a magnetic head or an optical head, be kept clean and free from dirt, dust and other contaminants. This thus requires regular cleaning of such interfaces.

Cleaning devices are provided for cleaning optical heads of optical disc read and/or write units, and such cleaning devices typically comprise a disc of similar size and shape to a conventional optical disc. One or more brushes are located on the disc, and the bristles or filaments of such brushes extend from the disc, so that when the disc is placed in an optical disc receiving area of the optical disc read and/or write unit, and the disc is rotated the bristles or filaments of the brush wipe the lens of the optical head as the brushes pass by the optical head. Such optical heads of optical read and/or write units must be precisely alignable with the optical disc, and thus, are highly precision constructed devices. Additionally, such optical heads are driven radially relative to the optical disc for reading data from the optical disc as the disc rotates, and the drive motor for radially driving the optical head must be capable of accurately and with precision positioning the head over a data track of the optical disc. In order to obtain the appropriate degree of precision, the power output of such drives for radially driving an optical head is relatively low. Additionally, the power output of the drive motor for rotating the optical disc in the optical disc receiving area is also relatively low. Impacting of brushes of such known cleaning devices with the read/write head as the disc rotates can lead to misalignment of the optical head, and furthermore, can lead to damage to the optical head. Indeed, where the frictional resistance between the brush and the optical head, or lens of the optical head is excessive as the disc is rotating, the drive motor which rotates the disc may burn out. Additionally, if the drive motor for radially driving the optical head is also driving the optical head radially while in engagement with a brush of the cleaning device, excessive friction between the brush and the optical head can also lead to burnout of the radial drive motor.

These are serious problems which may result from the use of such cleaning devices known heretofore for cleaning optical heads of optical read and/or write units, and substantially similar type problems arise with cleaning devices which are provided for cleaning magnetic heads of read and/or write units.

There is therefore a need for a cleaning device for a read and/or write head or other interface of a read and/or write unit, and/or a playback and/or recorder unit, which minimises the likelihood of damage to the read and/or write interface of the unit.

The present invention is directed towards providing a cleaning device for cleaning a read and/or write interface of a read and/or write unit, and/or playback and/or recorder unit which addresses the problems resulting from the use of cleaning devices known heretofore, and which minimises the likelihood of damage to the read and/or write interface. The invention is also directed towards providing a method for producing such a cleaning device.

According to the invention there is provided a cleaning device for cleaning a read and/or write interface of a read and/or write unit, and/or a playback and/or recorder unit, the device comprising a carrier means for locating in a recordable medium receiving area of the unit, a receiving recess being formed in the carrier means, and a cleaning means having a first portion and a second portion, the first portion of the cleaning means being located in the receiving recess and secured to the carrier means therein, and the second portion of the cleaning means extending from the receiving recess and being flexible relative to the first portion thereof, the receiving recess being of size relative to the first portion of the cleaning means such that the flexibility of the second portion of the cleaning means relative to the first portion thereof is uninhibited, and the receiving recess being located in the carrier means so that when one of the carrier means and the interface is moved relative to the other, the second portion of the cleaning means co-operates with the interface for cleaning thereof.

Preferably, the receiving recess is of depth relative to the depth of the first portion of the cleaning means so that the flexibility of the second portion of the cleaning means relative to the first portion thereof is uninhibited.

Advantageously, the depth of the receiving recess is greater than the depth of the first portion of the cleaning means. Preferably, the depth of the receiving recess lies in the range of one and a half times to two and a half times the depth of the first portion of the cleaning means, and advantageously, the depth of the receiving recess is approximately twice the depth of the first portion of the cleaning means.

Preferably, the receiving recess is of area in plan view relative to the area in plan view of the first portion of the cleaning means so that the flexibility of the second portion of the cleaning means relative to the first portion thereof is uninhibited, and advantageously, the area in plan view of the receiving recess is substantially similar to the area in plan view of the first portion of the cleaning means.

In one embodiment of the invention the receiving recess is formed in the carrier means for locating the cleaning means at a location corresponding to a location to which the interface is initially moved for reading identifying data on a data recordable medium, so that when one of the carrier means and the interface is moved relative to the other, the second portion of the cleaning means co-operates with the interface for cleaning thereof.

In another embodiment of the invention the receiving recess is formed in the carrier means at a location so that when the carrier means is placed in the receiving area, the second portion of the cleaning means engages the interface at a location taken up by the interface when the unit is powered down for protecting the interface.

In a further embodiment of the invention the second portion of the cleaning means is of size to embrace the interface for protecting the interface when the interface is at the location taken up by the interface when the unit is powered down.

Preferably, the receiving recess is formed in the carrier means at a location so that when the carrier means is placed in the receiving area, the second portion of the cleaning means engages the interface at a location taken up by the interface when the unit is powered down for protecting the interface, and the second portion of the cleaning means engages the interface when the interface is initially moved for reading identifying data on a data recordable medium for cleaning thereof.

Preferably, the second portion of the cleaning means is of area in plan view which is greater than the area in plan view of the interface.

In one embodiment of the invention the first portion of the cleaning means comprises a base member. Preferably, the base member is of woven material. Advantageously, the second portion of the cleaning means comprises a plurality of inherently resiliently flexible filaments extending from the base member. Preferably, the filaments of the second portion of the cleaning means are tufted into the base member. Advantageously, the tufting of the filaments in the base member is such as to facilitate limited hinging of the filaments relative to the base member, thereby providing flexibility of the filaments relative to the base member. Ideally, the depth of the receiving recess is such as not to inhibit the limited hinging of the filaments relative to the base member.

In one embodiment of the invention the filaments forming the second portion of the cleaning means extend from the base member a distance in the range of 2 mm to 7 mm. Preferably, the filaments forming the second portion of the cleaning means extend from the base member a distance in the range of 3.5 mm to 6.5 mm. Advantageously, the filaments forming the second portion of the cleaning means extend from the base member a distance of approximately 4 mm.

In one embodiment of the invention the filaments forming the second portion of the cleaning means are of diameter in the range of 2 microns to 10 microns. Preferably, the filaments forming the second portion of the cleaning means are of diameter in the range of 2 microns to 7 microns. Advantageously, the filaments forming the second portion of the cleaning means are of diameter of approximately 4 microns.

In another embodiment of the invention the density of the filaments forming the second portion of the cleaning means is in the range of 2,000 filaments per cm² of the base member to 6,000 filaments per cm² of the base member. Preferably, the density of the filaments forming the second portion of the cleaning means is approximately 4,000 filaments per cm² of the base member.

In a further embodiment of the invention the filaments forming the second portion of the cleaning means are of a plastics material. Advantageously, the material of the filaments forming the second portion of the cleaning means are selected from one or more of the following plastics materials:
nylon,
rayon, and
polypropylene.

In one embodiment of the invention the base member forming the first portion of the cleaning means is of a plastics material. Advantageously, the material of the base member forming the first portion of the cleaning means is selected from one or more of the following plastics materials:
nylon,
rayon, and
polypropylene.

In one embodiment of the invention the carrier means is formed by one of press forming or moulding, and preferably, the receiving recess is formed in the carrier means during forming of the carrier means by the press forming or moulding. Advantageously, the carrier means is of a plastics material.

In one embodiment of the invention the cleaning means is adapted for cleaning an interface provided by a lens of an optical head of an optical disc read and/or write unit.

In another embodiment of the invention the carrier means comprises a carrier disc. Preferably, the carrier disc is of size similar to a data recordable disc for use with the read and/or write unit.

Advantageously, the receiving recess is formed in the carrier disc at a location corresponding to an inner data recordable track of a data recordable disc to which the carrier disc corresponds.

In one embodiment of the invention the receiving recess is of circular shape when viewed in plan. Preferably, the receiving recess is of diameter in the range of 0.5 mm to 20 mm. Advantageously, in which the receiving recess is of diameter in the range of 6 mm to 15 mm. Ideally, the receiving recess is approximately 11 mm.

In another embodiment of the invention the first portion of the cleaning means is of circular shape when viewed in plan.

The invention also provides a method for producing a cleaning device for cleaning a read and/or write interface of a read and/or write unit, and/or a recorder and/or playback unit, the method comprising forming a carrier means for engaging in a recordable medium receiving area of the unit, forming a receiving recess in the carrier means for receiving a cleaning means having a first portion and a second portion, locating the first portion of the cleaning means in the receiving recess with the cleaning means secured to the carrier means therein, and with a second portion of the cleaning means extending from the carrier means, the second portion of the cleaning means being flexible relative to the first portion thereof, the receiving recess being formed of size relative to the first portion of the cleaning means such that the flexibility of the second portion of the cleaning means relative to the first portion thereof is uninhibited, and the receiving recess being formed in the carrier means at a location so that when the carrier means is engaged in the receiving area and one of the carrier means and the interface is moved relative to the other, the cleaning means co-operates with the interface for cleaning thereof.

Preferably, the receiving recess is formed in the carrier means to a depth relative to the depth of the first portion of the cleaning means so that the flexibility of the second portion of the cleaning means relative to the first portion thereof is uninhibited. Advantageously, the receiving recess is formed in the carrier means to a depth relative to the depth of the first portion of the cleaning means so that the flexibility of the second portion of the cleaning means relative to the first portion thereof is uninhibited. Ideally, the receiving recess is formed to be of depth greater than the depth of the first portion of the cleaning means.

The advantages of the invention are many. The cleaning device according to the invention cleans the read and/or write interface of a read and/or write unit, and/or a playback and/or recorder unit without damaging the read and/or write interface or the read and/or write unit, and/or the playback and/or recorder unit. This is achieved by virtue of the fact that the second portion of the cleaning means is flexible relative to the first portion thereof, and the receiving recess is of size so that when the first portion of the cleaning means is secured in the receiving recess, the flexibility of the second portion of the cleaning means is not inhibited relative to the first portion thereof. Providing the first portion of the cleaning means as a base member and the second portion of the cleaning means as filaments, which are flexible relative to the base member and which extend from the base member provides the added advantage that the filaments flex relative to the base member as they pass the read and/or write interface, thereby avoiding excessive force and/or pressure on the read and/or write interface as the cleaning means passes the interface. Additionally, by providing the first portion of the cleaning means to be of depth less than the depth of the receiving recess, and by locating the first portion of the cleaning means in the recess, there is no danger of the first portion of the cleaning means coming into contact with the read and/or write interface, and where the first portion of the cleaning means comprises a base member, there is no danger of damage to the read and/or write interface resulting from impact with the first portion of the cleaning means.

By providing the receiving recess of size relative to the first portion of the cleaning means such that the flexibility of the second portion of the cleaning means relative to the first portion thereof is uninhibited further ensures that damage to the read and/or write interface as the cleaning means passes the read and/or write interface is minimised. A particularly important advantage of the invention is achieved when the cleaning means is provided with the first portion thereof in the form of a base member and the second portion thereof provided by resilient flexible filaments extending from the base member, in that the filaments being flexible avoid excessive force and pressure being applied to the read and/or write interface, while at the same time the resilience of the filaments ensures adequate cleaning of the read and/or write interface. By providing the base member of the cleaning means as a woven base member and the filaments as being tufted into the woven base member, a further advantage is achieved in that the tufting of the filaments in the woven base facilitates limited hinging of the filaments relative to the woven base member, thus providing further flexibility of the filaments relative to the base member of the cleaning means.

A further advantage of the cleaning device according to the invention is achieved when the receiving recess and the cleaning means are located at a location corresponding to the location to which the read and/or write interface is initially moved for reading identifying data on a data recordable medium. This ensures that as the carrier means is moving in the recordable medium receiving area while the read and/or write interface is being positioned in the initial location for reading the identifying data, the read and/or write interface is wiped by the cleaning means for cleaning thereof. Indeed, where the cleaning device is provided for cleaning a lens of an optical head of an optical disc, while in its initial position attempting to focus for reading identifying data, the optical head is moved towards and away from the cleaning means, thereby further enhancing the cleaning action achieved by the cleaning means. Furthermore, by virtue of the fact that the second portion of the cleaning means is flexible relative to the first portion thereof, damage to the optical head and in particular, the lens is minimised.

A further advantage is achieved by the cleaning device according to the invention when the receiving recess is formed in the carrier means at a location which corresponds to a location which is taken up by the read and/or write interface when the read and/or write unit is powered down. In this case, the cleaning means as well as acting to clean the read and/or write interface, can also act to protect the read and/or write interface from shock, dirt and dust when the read and/or write unit is powered down. This is particularly so in cases where the area in plan view of the second portion of the cleaning means, which in one embodiment of the invention comprises filaments, is such that the cleaning means embraces the read and/or write interface when the read and/or write unit is powered down once the cleaning device is located in the recordable medium receiving area with the cleaning means aligned with the powered down location of the read and/or write interface.

The invention will be more clearly understood from the following description of a preferred embodiment thereof, which is given by way of example only, with reference to the accompanying drawings, in which:

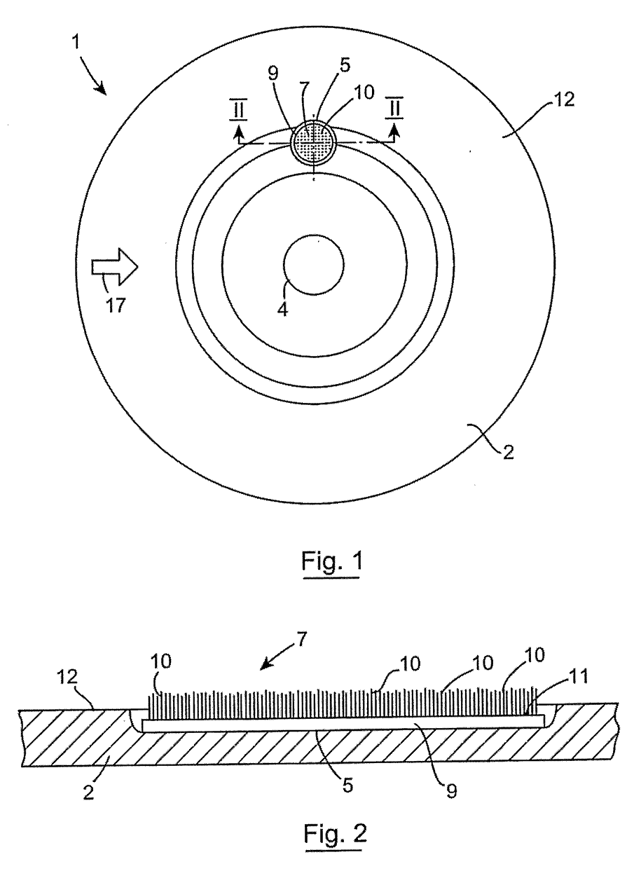

FIG. 1 is a top plan view of a cleaning device according to the invention,

FIG. 2 is an enlarged transverse cross-sectional side elevational view of a portion of the cleaning device of FIG. 1 on the line II-II of FIG. 1,

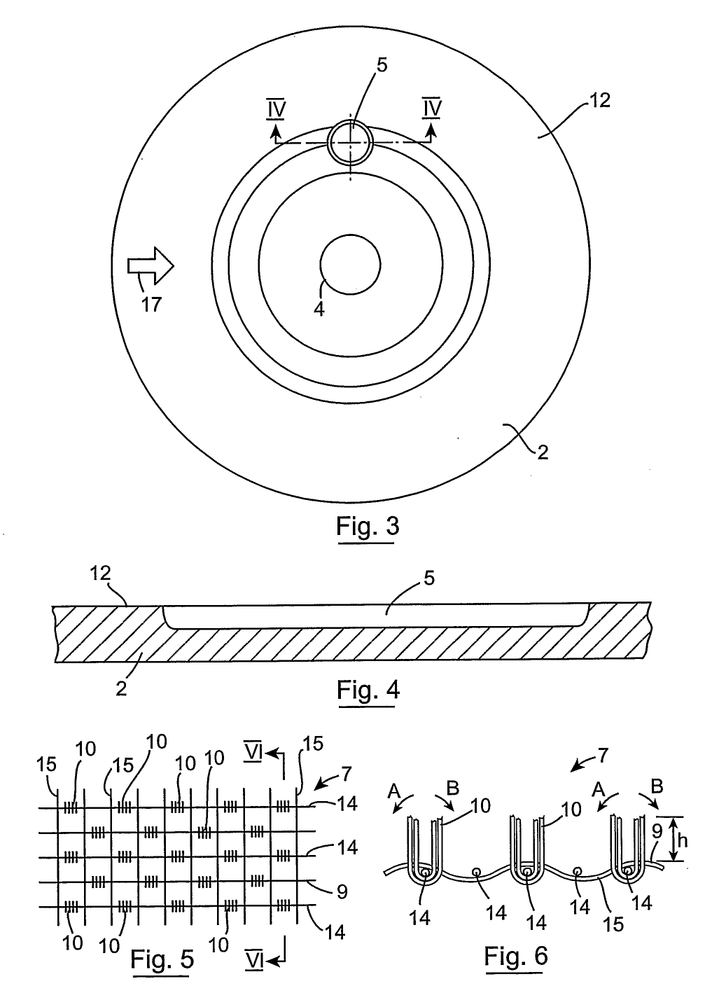

FIG. 3 is a top plan view of a portion of the cleaning device of FIG. 1,

FIG. 4 is an enlarged transverse cross-sectional side elevational view of a portion of the portion of the cleaning device of FIG. 3 on the line IV-IV of FIG. 3,

FIG. 5 is a diagrammatic top plan view of another portion of the cleaning device of FIG. 1, and

FIG. 6 is a diagrammatic transverse cross-sectional side elevational view of the portion of FIG. 5 of the cleaning device of FIG. 1 on the line VI-VI of FIG. 5.

Referring to the drawings, there is illustrated a cleaning device according to the invention, indicated generally by the reference numeral 1, for cleaning a read and/or write interface, in this case, a lens of an optical read/write head of an optical disc drive unit, neither the optical disc drive unit, the lens or the optical head are illustrated. However, such optical disc drive units will be well known to those skilled in the art. The optical disc drive unit may be adapted for reading data from and/or writing data to a recordable medium, which in this case would be a music compact disc or a CD-ROM disc. The optical disc drive unit is provided with a disc receiving area for receiving a music compact disc or a CD-ROM disc, and the optical head is located adjacent the disc receiving area for reading data from and writing data to the disc as the disc is rotated in the disc receiving area by a disc drive motor. Additionally, the optical head is driven radially relative to the disc by a radial drive motor as the disc rotates for aligning the optical head with respective data tracks of the music compact disc or CD-ROM disc, so that data can be read from or written to the compact disc or CD-ROM disc. The lens of the optical head is also urged towards and away from the surface of the compact disc or CD-ROM disc for focusing on data tracks of the compact disc or CD-ROM disc.

The cleaning device 1 comprises a carrier means which is provided in the form of a carrier disc 2 of similar dimensions to those of a compact disc or a CD-ROM disc, and which is suitable for locating in the disc receiving area of the optical disc drive unit. The carrier disc 2 is of plastics material and is formed by injection moulding. A central bore 4 extends through the carrier disc 2, which is similar to the central bore which extends through a conventional compact disc or CD-ROM disc.

A receiving recess 5 is formed in the carrier disc 2 during the injection moulding of the carrier disc 2 for receiving a cleaning means, in this embodiment of the invention a brush type element 7 for cleaning the lens of the optical head as will be described below. The brush type element 7 comprises a first portion, namely, a base member 9 which is located in the receiving recess 5, and a second portion, namely, a plurality of inherently resiliently flexible filaments 10 extending upwardly from the base member 9. The base member 9 is formed of a woven material and comprises warp and weft threads 14 and 15, respectively. The filaments 10 are formed in tufts, which are formed around the warp threads 14 of the woven base member 9, see FIGS. 5 and 6. The depth of the woven base member 9 is approximately 0.2 mm, and the depth of the receiving recess 5 is approximately 0.4 mm, so that the base member 9 is completely located within the recess 5 with a top surface 11 of the base member 9 being below a top surface 12 of the carrier disc 2. The woven base member 9 of the brush type element 7 and in turn the total area defined by the filaments 10 in plan view are circular in plan view, as is the receiving recess 5. The base member 9 and the total area defined by the filaments 10 in plan view are of diameter of 10.7 mm approximately, and the receiving recess 5 is of diameter of 11 mm approximately. An adhesive (not shown) bonds the base member 9 of the brush type element 7 to the carrier disc 2 in the receiving recess 5.

The warp and weft threads 14 and 15 of the base member are of a plastics material, and may be of nylon, rayon or polypropylene, or a mix of two or more of these materials. The filaments 10 of the brush type element 7 are of a synthetic continuous filament material and may be of nylon, rayon or polypropylene or a combination of two or more of these materials. The diameter of the filaments 10 may range from 2 microns to 7 microns, and typically, on average, are of 4 microns. The density of the filaments 10 on the base member 9 is approximately 4,000 filaments per cm² of the base member 9, and the filaments extend to a height h of approximately 4 mm above the base member 9, see FIG. 6, although the height of the filaments will depend on the application for which the cleaning device 1 is being provided, and may range from 2 mm to 7 mm or more.

By tufting the filaments 10 to the woven base member 9, the filaments 10 can hinge to a limited degree relative to the base member 9 in the direction of the arrows A and B, see FIG. 6, and this imparts an additional degree of flexibility to the filaments 10 over and above the inherent resilient flexibility of the filaments 10. By providing the receiving recess 5 to be of depth 0.4 mm and the woven base member 9 to be of depth of approximately 0.2 mm, the flexibility of the filaments 10 relative to the woven base 9 due to the limited hinging effect, and the inherent resilient flexibility of the filaments is uninhibited by the carrier disc 2. Additionally, by providing the receiving recess 5 to be of depth of 0.4 mm and the depth of the woven base member 9 to be of depth of 0.2 mm, the area in plan view of the receiving recess 5 and the area in plan view of the woven base member 9 can be substantially similar, without inhibiting the flexibility of the filaments 10 relative to the woven base member 9.

Additionally, in this embodiment of the invention the receiving recess 5 is formed in the carrier disc 2 at a radial location which corresponds with and spans two locations of the optical head, namely, a rest or inactive position which the optical head takes up when the optical disc drive unit is powered down, and a location to which the optical head is initially moved in order to read identification data from a compact disc in order to identify the location of data thereon. In optical disc drive units, the location to which the optical head is initially moved to read identification data corresponds with the inner data track of a music compact disc or a CD-ROM disc, since the identification data is written in the inner data track. In the majority of optical disc drive units the radial distance between the rest or inactive position of the optical head and the initial location to which the optical head is moved to read identification data is only one or two millimetres, and by providing the receiving recess 5 to be of diameter of the order of 11 mm, the receiving recess 5 when appropriately radially located on the carrier disc 2 can span both locations of the optical head. Since both of these locations of the optical head are adjacent the inner data track of a music compact disc or a CD-ROM disc, the receiving recess 5 is formed on the carrier disc 2 at an appropriate radial location corresponding to the radial position of an inner data track of a music compact disc or a CD-ROM disc. Since the lens of the optical head of the majority of optical disc drive units is of diameter of the order of 4 mm to 5 mm, and since the diameter of the brush type element 7 is of approximately 10.7 mm, with a radial movement of the order of only 1 mm to 2 mm of the optical head between the two locations, namely, the rest or inactive position and the location to which the optical head is initially moved to read identification data, the brush type element 7 is engageable with the lens in both locations of the optical head.

When the cleaning device 1 is located in the disc receiving area of the optical disc drive unit, and when the unit is activated, the carrier disc 2 is rotated, and the optical head is radially urged from the rest or inactive position to the location corresponding to the location of the inner data track of a music compact disc or CD-ROM disc. The rotation of the carrier disc 2 results in the brush type element 7 wiping the lens for cleaning thereof on each pass of the brush type element past the optical head. Furthermore, since no identification data is recorded on the carrier disc 2, the optical head is unable to read data therefrom, and accordingly, the optical head attempts to focus on the carrier disc 2 by urging the lens towards and away from the top surface 12 of the carrier disc 2 in a direction perpendicular to the top surface 12 with a reciprocating type action. This reciprocating action urges the lens into and/or out of the filaments 10 of the brush type element 7 on each pass of the brush type element 7, which further enhances the cleaning action of the brush type element 7 on the lens. Additionally, the inability of the optical head to read data from the carrier disc 2 also causes the optical head to traverse radially backwards and forwards across the carrier disc 2 parallel to the top surface 12 thereof in an attempt to locate the inner data track. This backward and forward movement of the optical head over the top surface 12 of the carrier disc 2 further enhances the cleaning action of the brush type element 7 on the lens of the optical head as the lens engages the brush type element 7 on each pass of the brush type element with relative movement between the brush type element 7 and the lens resulting from the circumferential movement of the brush type element 7 and the radial movement of the optical head.

Additionally, since the radial location of the brush type element 7 on the carrier disc 2 also corresponds with the rest or inactive position of the optical head, by locating the carrier disc 2 in the disc receiving area of the optical disc drive unit so that the carrier disc 2 is oriented therein with the brush type element 7 coinciding and substantially aligned with the lens when the optical head is in the rest or inactive position, the lens is engaged by the brush type element 7 when the optical disc drive unit is powered down. The length and resilience of the filaments 10 of the brush type element 7 are such that when the lens is so engaged by the filaments of the brush type element 7, the brush type element 7 acts as a protective means for protecting the lens and the optical head from shock when the optical disc drive unit is powered down. Additionally, since the diameter of the brush type element is approximately 10.7 mm, which is considerably greater than the diameter of the lens of the optical head, the lens nests within the filaments 10 of the brush type element 7 with the filaments 10 of the brush type element 7 adjacent the outer periphery of the lens effectively embracing the lens, thereby protecting the lens from dust and dirt and other debris as well as shock when the optical disc drive unit is powered down. Accordingly, as well as acting as a cleaning means for cleaning the lens of an optical head of an optical disc drive unit, the brush type element 7 also acts to protect the lens from dirt, dust and debris when the optical disc drive unit is powered down, and also acts to protect the lens and the optical head from shock also when the disc drive unit is powered down.

An orientation indicating means for indicating the orientation in which the carrier disc 2 should be inserted in the disc receiving area of the optical disc drive unit is provided by an orientation indicating arrow 17 on the top surface 12 of the carrier disc 2 for indicating the orientation in which the carrier disc 2 should be entered in the disc receiving area of the optical disc drive unit, so that the brush type element 7 is aligned with the lens of the optical head when the optical head is in the rest or inactive position with the optical disc drive unit powered down for protecting the lens of the optical head. It is envisaged that in certain cases, a number of orientation indicating arrows similar to the orientation arrow 17 may be located on the top surface 12 of the carrier disc 2 for indicating appropriate orientations in which the carrier disc 2 should be entered in different types of optical disc drive units. To form the receiving recess 5 in the carrier member 2 during injection moulding of the carrier disc 2, an insert corresponding to the shape and size of the receiving recess 5 is appropriately located in a cavity of the mould in which the carrier disc 2 is moulded for forming the receiving recess 5 during injection moulding of the carrier disc 2.

In use, to clean the lens of an optical head of an optical disc drive unit, the cleaning device 1 is placed in the disc receiving area of the optical disc drive unit, and the optical disc drive unit is activated. The carrier disc 2 is rotated in the compact disc receiving area by the disc drive motor, and the optical head is urged to the location corresponding to the inner data track of a conventional compact disc. With the carrier disc 2 rotating, the filaments 10 of the brush element 7 wipe the lens of the optical head on each revolution of the carrier disc 2, thereby cleaning the lens of the optical head. Furthermore, as the optical head attempts to focus on the carrier disc 2, the lens reciprocates perpendicularly relative to the top surface 12 of the carrier disc 2, thereby further enhancing cleaning of the lens. Additionally, the optical head traverses radially with a reciprocating action parallel to the top surface 12 of the carrier disc 2 in an attempt to locate identification data. This reciprocating action of the optical head further enhances cleaning of the lens.

When the optical disc drive unit is not in use, the cleaning device is located in the disc receiving area of the optical disc drive unit with the brush type element 7 located at a location to engage and embrace the lens of the optical head of the optical disc drive unit in the rest or inactive position of the optical head when the optical disc drive unit is powered down, in order to protect the lens from dirt, dust and other debris and to protect the lens and the optical head from shock. This is achieved by entering the carrier disc 2 in the appropriate orientation indicated by the appropriate orientation indicating arrow 17.

While the cleaning device according to the invention has been described for cleaning and protecting an optical read/write head of an optical disc drive unit, which reads and writes data from and to a music compact disc or a CD-ROM disc, the cleaning device may be provided for use in any other read and/or write unit, for example, a read and/or write DVD unit, a CD game unit, an MP3 unit, a digital camcorder, or any other device suitable for reading and/or writing data in which the read and/or write head includes a lens for facilitating optical reading of the data. Additionally, it is envisaged that in certain cases, the cleaning device according to the invention may be adapted for cleaning a magnetic head of a magnetic data read and/or write unit, and it is further envisaged that the cleaning device may be adapted for protecting such a magnetic head of a magnetic read and/or write unit from dust, dirt and/or shock.

It is also envisaged that the cleaning device according to the invention may be provided for cleaning an interface, such as electrical contacts of the type provided in a memory stick, a compact flashcard, an SD card, a game card or the like, as well as corresponding interface contacts of a read and/or write unit with which such sticks and/or cards are engageable. In which case, it is envisaged that the cleaning device would also be provided to protect such interface contacts from dirt, dust and shock.

Additionally, while the cleaning device has been described as comprising a carrier means formed by a compact disc, the carrier means may be formed by any other suitable carrier, and it will be readily apparent to those skilled in the art that the type of carrier means, the dimensions, size and shape of the carrier means will in general be dictated by the type of read and/or write unit or the type of playback and/or recorder unit for which the cleaning device is to be provided for cleaning a read and/or write interface thereof. Additionally, it will be appreciated that the dimensions, size and shape of the carrier means need not necessarily be similar to those of the data carrier for which the read and/or write unit is adapted to read and/or write data from or to.

It will also be appreciated that while the recess in the carrier disc has been described as being of a particular shape and size, and while the cleaning means has also been described as being of a particular shape and size, the recess may be formed of other shapes and sizes, as may the cleaning means be formed of other shapes and sizes.

While the cleaning means has been described as comprising a base member of specific materials and of specific depth, the base member may be of other suitable materials and other suitable depths. Additionally, while the cleaning means has been described as comprising filaments of specific materials and dimensions, it will be readily apparent to those skilled in the art that filaments of other suitable materials and other suitable dimensions may be provided. Indeed, it is envisaged that the height to which the filaments extend above the base member may be considerably greater than 4 mm, and the height will largely depend on the application for which the device is being provided. It is also envisaged that the diameter of the filaments may be greater or lesser than that described, and typically, may be within a range of 2 microns to 10 microns, or greater. The density of the filaments on the base member likewise may be other than that described, and it is envisaged that the density of the filaments may be in the range of 2,000 to 6,000 filaments per cm² of the base member, and in certain cases may be of density lesser or greater than this range.

1-67. (canceled)

68. A cleaning device for cleaning a read and/or write interface of a read and/or write unit, and/or a playback and/or recorder unit, the device comprising a carrier means for locating in a recordable medium receiving area of the unit, a receiving recess being formed in the carrier means, and a cleaning means having a first portion and a second portion, the first portion of the cleaning means being located in the receiving recess and secured to the carrier means therein, and the second portion of the cleaning means extending from the receiving recess and being flexible relative to the first portion thereof, the receiving recess being of size relative to the first portion of the cleaning means such that the flexibility of the second portion of the cleaning means relative to the first portion thereof is uninhibited, and the receiving recess being located in the carrier means so that when one of the carrier means and the interface is moved relative to the other, the second portion of the cleaning means co-operates with the interface for cleaning thereof.

69. A device as claimed in claim 68 in which the receiving recess is of depth relative to the depth of the first portion of the cleaning means so that the flexibility of the second portion of the cleaning means relative to the first portion thereof is uninhibited.

70. A device as claimed in claim 68 in which the depth of the receiving recess is greater than the depth of the first portion of the cleaning means, and preferably, the depth of the receiving recess lies in the range of one and a half times to two and a half times the depth of the first portion of the cleaning means, and advantageously, the depth of the receiving recess is approximately twice the depth of the first portion of the cleaning means, and preferably, the receiving recess is of area in plan view relative to the area in plan view of the first portion of the cleaning means so that the flexibility of the second portion of the cleaning means relative to the first portion thereof is uninhibited, and advantageously, the area in plan view of the receiving recess is substantially similar to the area in plan view of the first portion of the cleaning means.

71. A device as claimed in claim 68 in which the receiving recess is formed in the carrier means for locating the cleaning means at a location corresponding to a location to which the interface is initially moved for reading identifying data on a data recordable medium, so that when one of the carrier means and the interface is moved relative to the other, the second portion of the cleaning means co-operates with the interface for cleaning thereof, and preferably, the receiving recess is formed in the carrier means at a location so that when the carrier means is placed in the receiving area, the second portion of the cleaning means engages the interface at a location taken up by the interface when the unit is powered down for protecting the interface, and advantageously, the second portion of the cleaning means is of size to embrace the interface for protecting the interface when the interface is at the location taken up by the interface when the unit is powered down, and preferably, the receiving recess is formed in the carrier means at a location so that when the carrier means is placed in the receiving area, the second portion of the cleaning means engages the interface at a location taken up by the interface when the unit is powered down for protecting the interface, and the second portion of the cleaning means engages the interface when the interface is initially moved for reading identifying data on a data recordable medium for cleaning thereof.

72. A device as claimed in claim 68 in which the second portion of the cleaning means is of area in plan view which is greater than the area in plan view of the interface.

73. A device as claimed in claim 68 in which the first portion of the cleaning means comprises a base member, and preferably, the base member is of woven material, and advantageously, the second portion of the cleaning means comprises a plurality of inherently resiliently flexible filaments extending from the base member, and preferably, the filaments of the second portion of the cleaning means are tufted into the base member, and advantageously, the tufting of the filaments in the base member is such as to facilitate limited hinging of the filaments relative to the base member, thereby providing flexibility of the filaments relative to the base member, and preferably, the depth of the receiving recess is such as not to inhibit the limited hinging of the filaments relative to the base member.

74. A device as claimed in claim 73 in which the filaments forming the second portion of the cleaning means extend from the base member a distance in the range of 2 mm to 7 mm, and preferably the filaments forming the second portion of the cleaning means extend from the base member a distance in the range of 3.5 mm to 6.5 mm, and advantageously, the filaments forming the second portion of the cleaning means extend from the base member a distance of approximately 4 mm.

75. A device as claimed in claim 73 in which the filaments forming the second portion of the cleaning means are of diameter in the range of 2 microns to 10 microns, and preferably, the filaments forming the second portion of the cleaning means are of diameter in the range of 2 microns to 7 microns, and advantageously the filaments forming the second portion of the cleaning means are of diameter of approximately 4 microns.

76. A device as claimed in claim 73 in which the density of the filaments forming the second portion of the cleaning means is in the range of 2,000 filaments per cm² of the base member to 6,000 filaments per cm² of the base member, and preferably, the density of the filaments forming the second portion of the cleaning means is approximately 4,000 filaments per cm² of the base member.

77. A device as claimed in claim 73 in which the filaments forming the second portion of the cleaning means are of a plastics material, and preferably, the material of the filaments forming the second portion of the cleaning means are selected from one or more of the following plastics materials:
nylon,
rayon, and
polypropylene.

78. A device as claimed in claim 73 in which the base member forming the first portion of the cleaning means is of a plastics material, and preferably, the material of the base member forming the first portion of the cleaning means is selected from one or more of the following plastics materials:
nylon,
rayon, and
polypropylene.

79. A device as claimed in claim 68 in which the carrier means is formed by one of press forming or moulding, and preferably, the receiving recess is formed in the carrier means during forming of the carrier means by the press forming or moulding, and advantageously, the carrier means is of a plastics material, and preferably, the cleaning means is adapted for cleaning an interface provided by a lens of an optical head of an optical disc read and/or write unit, and advantageously, the carrier means comprises a carrier disc, and preferably, the carrier disc is of size similar to a data recordable disc for use with the read and/or write unit, and advantageously, the receiving recess is formed in the carrier disc at a location corresponding to an inner data track of a data recordable disc to which the carrier disc corresponds, and preferably, the receiving recess is of circular shape when viewed in plan, and preferably, the receiving recess is of diameter in the range of 0.5 mm to 20 mm, and advantageously, the receiving recess is of diameter in the range of 6 mm to 15 mm, and preferably, the receiving recess is approximately 11 mm, and advantageously, the first portion of the cleaning means is of circular shape when viewed in plan.

80. A method for producing a cleaning device for cleaning a read and/or write interface of a read and/or write unit, and/or a recorder and/or playback unit, the method comprising forming a carrier means for engaging in a recordable medium receiving area of the unit, forming a receiving recess in the carrier means for receiving a cleaning means having a first portion and a second portion, locating the first portion of the cleaning means in the receiving recess with the cleaning means secured to the carrier means therein, and with a second portion of the cleaning means extending from the carrier means, the second portion of the cleaning means being flexible relative to the first portion thereof, the receiving recess being formed of size relative to the first portion of the cleaning means such that the flexibility of the second portion of the cleaning means relative to the first portion thereof is uninhibited, and the receiving recess being formed in the carrier means at a location so that when the carrier means is engaged in the receiving area and one of the carrier means and the interface is moved relative to the other, the cleaning means co-operates with the interface for cleaning thereof.

81. A method as claimed in claim 80 in which the receiving recess is formed in the carrier means to a depth relative to the depth of the first portion of the cleaning means so that the flexibility of the second portion of the cleaning means relative to the first portion thereof is uninhibited, and preferably, the receiving recess is formed in the carrier means to a depth relative to the depth of the first portion of the cleaning means so that the flexibility of the second portion of the cleaning means relative to the first portion thereof is uninhibited, and advantageously, the receiving recess is formed to be of depth greater than the depth of the first portion of the cleaning means, and preferably, the depth of the receiving recess lies in the range of one and a half times to two and a half times the depth of the first portion of the cleaning means, and advantageously, the receiving recess is of area in plan view relative to the area in plan view of the first portion of the cleaning means so that the flexibility of the second portion of the cleaning means relative to the first portion thereof is uninhibited, and preferably, the area in plan view of the receiving recess is substantially similar to the area in plan view of the first portion of the cleaning means.

82. A method as claimed in claim 80 in which the receiving recess is formed in the carrier means for locating the cleaning means at a location corresponding to a location to which the interface is initially moved for reading identifying data on a data recordable medium, so that when one of the carrier means and the interface is moved relative to the other, the second portion of the cleaning means co-operates with the interface for cleaning thereof.

83. A method as claimed in claim 80 in which the receiving recess is formed in the carrier means at a location so that when the carrier means is placed in the receiving area, the second portion of the cleaning means engages the interface at a location taken up by the interface when the unit is powered down for protecting the interface, and advantageously, the second portion of the cleaning means is of size to embrace the interface for protecting the interface when the interface is at the location taken up by the interface when the unit is powered down.

84. A method as claimed in claim 80 in which the receiving recess is formed in the carrier means at a location so that when the carrier means is placed in the receiving area, the second portion of the cleaning means engages the interface at a location taken up by the interface when the unit is powered down for protecting the interface, and the second portion of the cleaning means engages the interface when the interface is initially moved for reading identifying data on a data recordable medium for cleaning thereof.

85. A method as claimed in claim 80 in which the second portion of the cleaning means is of area in plan view which is greater than the area in plan view of the interface, and preferably, the first portion of the cleaning means is formed from a base member, and advantageously, the base member is formed from woven material.

86. A method as claimed in claim 85 in which the second portion of the cleaning means is formed of a plurality of inherently resiliently flexible filaments extending from the base member, and advantageously, the filaments of the second portion of the cleaning means are tufted into the base member, and preferably, the tufting of the filaments in the base member is such as to facilitate limited hinging of the filaments relative to the base member, thereby providing flexibility of the filaments relative to the base member.

87. A method as claimed in claim 80 in which the carrier means is formed by one of press forming or moulding, and preferably, the receiving recess is formed in the carrier means during forming of the carrier means by the press forming or moulding, and advantageously, the carrier means is formed of a plastics material, and preferably, the cleaning means is formed of a plastics material, and advantageously, the cleaning means is adapted for cleaning an interface provided by a lens of an optical head of an optical disc read and/or write unit, and preferably, the carrier means comprises a carrier disc of size similar to a data recordable disc for use with the read and/or write unit, and advantageously, the receiving recess is of circular shape when viewed in plan, and preferably, the first portion of the cleaning means is of circular shape when viewed in plan.
